(19) United States
(12) Patent Application Publication
(10) Pub. No.: US 2006/0089869 A1
(43) Pub. Date: Apr. 27, 2006

(54) Systems and methods for automated reporting of vendor non-compliance

(75) Inventor: Steve Mundy, El Dorado Hills, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/970,013

(22) Filed: Oct. 21, 2004

(51) Int. Cl. G06F 17/60

(52) U.S. Cl. 705/11; 705/9

(57) ABSTRACT

Systems and methods are disclosed for automated reporting of any vendor noncompliance with purchaser-specified requirements in handling shipment of ordered products. The invention receives base data related to a purchaser order from a purchaser. Meanwhile, it obtains shipping data related to a shipment of ordered product in fulfillment of the purchaser order by a vendor. After comparing the shipping data against the base data, a vendor noncompliance report can be automatically generated. Based upon the shipping data in combination with the base data, the present invention can generate various reports for the purchaser to track shipment status of ordered products and check a variety of vendors' performances.

### FIELD OF THE INVENTION

The present invention generally relates to the field of vendor compliance with purchasing guidelines. In particular, the present invention provides systems and methods for facilitating vendor compliance with a purchaser's routing rules in shipping ordered merchandise by means of automated tracking and reporting vendors' non-compliant activities.

### BACKGROUND OF THE INVENTION

“Vendor compliance” generally refers to the rules by which vendors are asked to conduct business with their purchasers. Typically, vendor compliance is important to manufacturers having multiple subsidiary plants or warehouses, and distribution companies having multiple retail stores. Often times a purchaser has hundreds or thousands of vendors supplying all sorts of merchandise. Without a common set of rules governing how all of those vendors must conduct business with the single purchaser, the purchaser's overall business operations (purchasing, receiving, inventory control, accounting, etc.) would be chaotic at best. The inefficiencies of operation would have to be passed onto the retail consumer, resulting in higher prices for the goods sold. Thus, vendor compliance has become an increasingly significant issue in the field of buying and selling goods or merchandise.

Typically, a purchaser sets up the rules of vendor compliance. These rules would include at least a routing guide that sets forth how to ship the merchandise from a vendor to a designated location, e.g., a subsidiary plant, a warehouse, a service center, a retail store, etc. A routing guide can specifically provide what carriers to use based upon shipment characteristics including weight, volume, and/or number of pieces, ship-from and ship-to addresses, packing list, bill of lading, manifest requirements, etc. Preferably, a web-based interface can be used for shipment scheduling to ensure timely delivery of merchandise.

Besides the use of a routing guide, vendor compliance may also include other information, such as general vendor performance guidelines, item, carton and pallet barcode label specifications, hanger, tag, ply bag specifications, setup and testing documentation and procedures.

To comply with the above-mentioned rules, vendors often need to make adjustments to their operations. They may be further required to implement additional controls and procedures to react to purchasers' requests. For instance, vendors may be required to fax shipment information to the purchasers, provide proof of delivery, and changing fulfillment process to meet different purchasers' requirements and/or business necessities. It can be readily appreciated that many of these controls and procedures imposed upon vendors could result in additional expenses to the vendors, and thus the vendors may not be receptive to such changes.

Presently, an alternative method for vendor compliance is to shift the duty upon the purchasers, i.e., letting a purchaser control vendors' manifesting systems and check on the status of order fulfillment and shipment request by each vendor. However, there are several practical difficulties with this approach. First of all, it can be exceedingly difficult to simultaneously deal with different manifesting processes employed by different vendors, which may involve a high volume roller system, bulk labeling, single piece handling, etc. As can be readily appreciated, in addition to dealing with different vendor manifesting systems, the purchaser may need to communicate with different carrier-supplied manifesting systems as well. The differences in these manifesting systems obviously can cause logistical difficulties. Considering a purchaser's own host manifesting system, the purchaser would be overburdened to manage routing and control documentation for each manifest type. This approach also adds additional costs (e.g., hardware or software, staff, skills) for the purchasers and vendors. Similar to the above method, eventually a large part of the additionally incurred expenses will be passed onto customers.

Therefore, there exists a need for an improved method for vendor compliance that would overcome some or all of the above-identified deficiencies existing in the present methods and systems.

### BRIEF SUMMARY OF THE INVENTION

The present invention seeks to track vendor compliance via automated reporting of any non-compliant occurrences on an almost real-time basis. In that effort, the present invention further seeks to employ existing purchase order data in combination with shipping data without incurring extra workload to produce and maintain additional data. Moreover, the present invention should be highly adaptable and configurable to meet different purchasers' requirements. To that end, the present invention includes at least two architectural configurations: it can be provided by a third-party application service provider (ASP) or be easily integrated into each purchaser's internal system.

In accordance with the present invention, the above objects and other objects, features, and advantages will be carried out by a method and system for automated reporting of vendor noncompliance.

According to one embodiment of the present invention, a method is provided as comprising the steps of: receiving, from a purchaser, base data associated with a purchase order, said purchaser placing said purchase order with a vendor, said base data comprising at least a purchase order number, a billing number and an authorized delivery service level; receiving, from a carrier, shipping data associated with said purchase order, said shipping data generated upon a shipment request from said vendor to said carrier, and said shipping data comprising at least said purchase order number, said billing number and an actual delivery service level; determining whether there is noncompliance by said vendor by comparing said shipping data against said base data in accordance with a set of pre-defined rules; and responsive to the determination that said noncompliance exists, reporting said noncompliance to said vendor and said purchaser. In one preferred embodiment, said shipping data is generated through the steps of: allowing said vendor to make said shipment request through a shipper application; upon said shipment request, said shipper application generating billing data associated with said purchase order, said billing data comprising at least said purchase order number, said billing number, said actual delivery service level and a shipment tracking number; and transferring said billing data to a shipping system of said carrier, said shipping system generating said shipping data.

In accordance with an alternative embodiment of the present invention, a method is provided as comprising the steps of: allowing a purchaser to set up a set of pre-defined rules for vendor compliance; receiving, from said purchaser, base data associated with a purchase order, said purchaser placing said purchase order with a vendor, said base data comprising at least a purchase order number, a billing number and an authorized delivery service level; receiving, from a carrier, shipping data associated with said purchase order, said shipping data generated upon a shipment request from said vendor to said carrier, and said shipping data comprising at least said purchase order number, said billing number and an actual delivery service level; determining whether there exists noncompliance by said vendor by comparing said shipping data against said base data in accordance with said set of pre-defined rules; and responsive to the determination that said noncompliance exists, reporting said noncompliance to said vendor and said purchaser.

Another embodiment of the present invention provides a system for automated reporting of vendor noncompliance. The system is comprised of a processing server and a database accessible to said processing server, said database storing base data associated with a plurality of purchase orders, said base data comprising at least a plurality of purchase order numbers, a plurality of billing numbers and a plurality of delivery service levels authorized by a purchaser; wherein, said processing server is configured for: receiving shipping data associated with a particular purchase order, said shipping data comprising at least a particular purchase order number, a particular billing number, and a particular actual delivery service level; searching said database to identify, from said base data, a particular base data corresponding to said particular purchase order based upon said particular purchase order number and said particular billing number; comparing said shipping data against said particular base data to determine whether there is noncompliance, and if so, reporting said noncompliance to said purchaser. In one preferred embodiment, said shipping data is generated in a carrier's shipping system through the steps of: receiving said particular purchase order from said purchaser; in response to receiving said particular purchase order, allowing a vendor to request from a carrier a shipment service for ordered products; generating billing data associated with said shipment service, said billing data including said particular purchase order number and said particular billing number; and receiving said billing data in said carrier's shipping system to generate said shipping data upon said shipment service.

Yet another embodiment of the present invention is a computer-readable medium for vendor compliance, said computer-readable medium comprising programmed instructions, said programmed instructions, when executed in a computer, comprising the steps of: receiving, from a purchaser, base data associated with a purchase order, said purchaser placing said purchase order with a vendor, said base data comprising at least a purchase order number, a billing number and an authorized delivery service level; receiving, from a carrier, shipping data associated with said purchase order, said shipping data generated upon a shipment request from said vendor to said carrier, and said shipping data comprising at least said purchase order number, said billing number and an actual delivery service level; determining whether there exists noncompliance by said vendor by comparing said shipping data against said base data in accordance with a set of pre-defined rules; and responsive to the determination that said noncompliance exists, reporting said noncompliance to said vendor and said purchaser.

In accordance with an alternative embodiment of the present invention, a method for a purchaser to track vendor compliance is provided. The method is comprised of the steps of: placing a purchase order with a vendor, said purchase order identifying products to be purchased; in response to receiving from said vendor a confirmation of order fulfillment, inputting base data associated with said purchase order for a noncompliance reporting application, said base data comprising at least a purchase order number, a billing to shipper number and specific delivery instructions for shipping said products; and receiving, from said noncompliance reporting application, a report of noncompliance by said vendor in handling a shipment of said products, wherein, said report is generated by said noncompliance reporting application through the steps of: storing said base data in a database; receiving, from a carrier's system, shipping data relating to said shipment of said products, said shipping data comprising at least said purchase order number, said billing to shipper number and actual delivery information; responsive to receiving said shipping data, searching said database to identify said base data for a comparison against said shipping data; and determining whether there is noncompliance based upon said comparison, and if so, including said noncompliance in said report.

A further embodiment of the present invention is a system for facilitating vendor compliance that comprises: a processing server; a database accessible to said processing server; and a reporting application, when executed in said processing server, comprising the steps of: receiving from a user base data relating to a plurality of purchase orders identifying products to be ordered, each of said plurality of purchase orders containing a purchase order number, a vendor identifier, a billing number identifying said user, a shipping destination and approved delivery specifications; storing said base data into said database; receiving from a carrier shipping data associated with said plurality of purchase orders, said shipping data including actual shipment statuses for each of said plurality of purchase orders; for each of said plurality of purchase orders, comparing respective shipping data against respective base data; and reporting vendor noncompliance that is identified from the comparison pursuant to a set of user-defined criteria.

### BRIEF DESCRIPTION OF THE SEVERAL VIEWS OF THE DRAWING(S)

FIG. 1a-b are high-level block diagrams illustrating different architectural configurations of the present invention.

FIG. 2 shows primary components constituting an automated vendor noncompliance reporting system according to one embodiment of the present invention.

FIG. 3a is a process flow diagram of one application module for processing purchaser order base data in the system of FIG. 2 according to one embodiment of the present invention.

FIG. 3b shows in detail purchaser order base data received by the application module in FIG. 3a according to one embodiment of the present invention.

FIG. 4a is a flow diagram of another application module for processing shipping data in the system of FIG. 2 according to one embodiment of the present invention.

FIG. 4b shows exemplary data fields in a shipping data table according to one embodiment of the present invention.

FIG. 5 is a process flow diagram of an application module for processing a shipment request according to one embodiment of the present invention.

FIG. 6 is a process flow diagram of an application module for automated reporting of vendor noncompliance according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

System Architecture

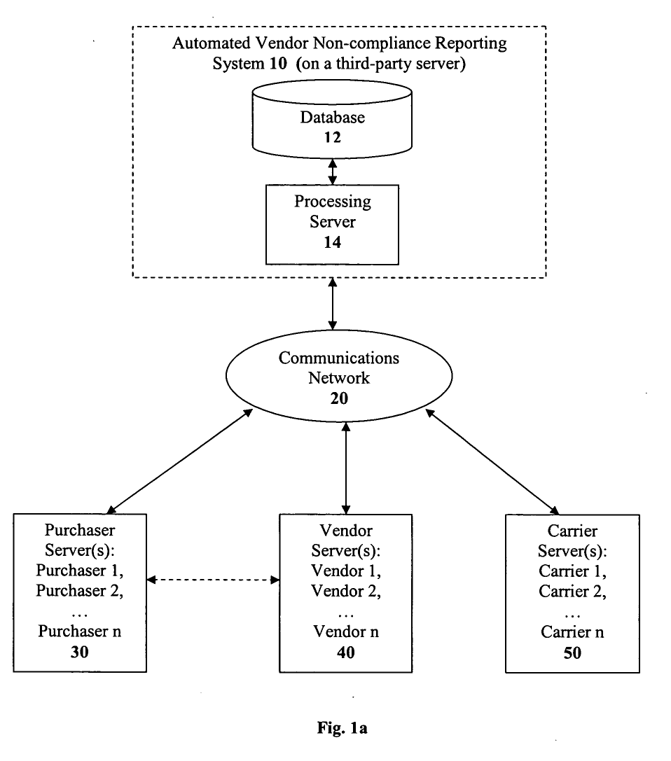

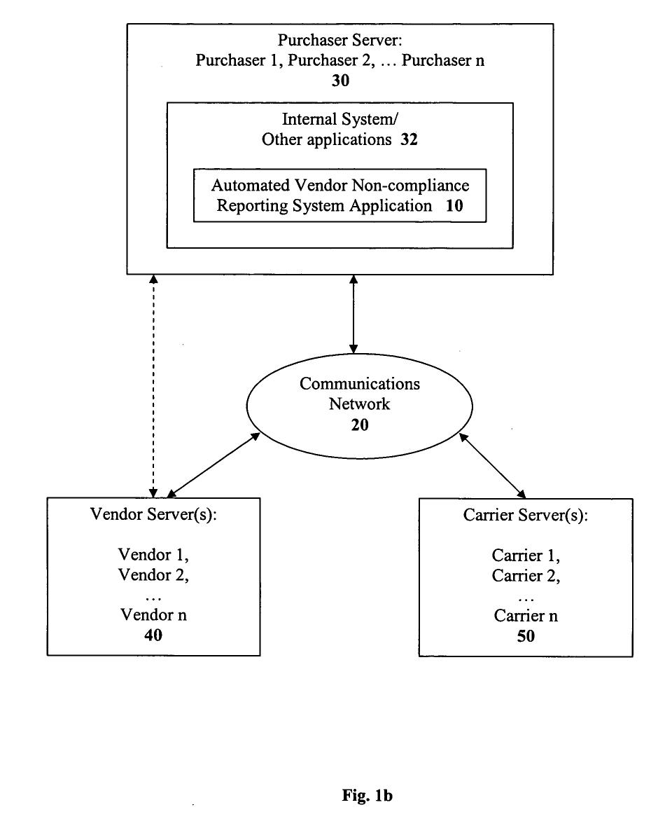

FIGS. 1a and 1b provide different architectural configurations of an Automated Vendor Noncompliance Reporting System (the “System”) 10.

Turning to FIG. 1a, the System 10 is built in an Application Service Provider (ASP) environment, meaning that the System 10 is operated in a third-party server computer. As seen in FIG. 1a, the System 10 is composed of a Database 12 that is accessible to a Processing Server 14. In a preferred embodiment, the System 10 is configured to communicate with three server computers operated by three entities involved in vendor compliance through a Communications Network 20, which can be the Internet, LAN, WAN or even a wireless communicating environment.

As is well known in the art, vendor compliance can involve a purchaser, one or more vendors who supply goods in fulfilling the purchaser's order, and one or more carriers designated by the purchaser to ship the ordered goods from vendors. Accordingly, FIG. 1a shows three types of server computers operated by the three entities: Purchaser Server(s) 30, Vendor Server(s) 40 and Carrier Server(s) 50. In a preferred embodiment, all these servers are capable of transmitting and receiving data over the Communications Network 20 using communication means including, but not limited to, standard Internet Protocols such as HTTP and HTTPS. Besides EDI (Electronic Data Transfer), the communication between purchasers, vendors and carriers can also be accomplished by electronic mails or web browsers for viewing data. Moreover, even if one or more entities are not connected to the Communications Network 20, the communication can be made through phones, fax machines or emails. For example, it is common practice for a purchaser to place an order with its vendors by means of telephone, fax or email.

FIG. 1b represents an alternative architectural configuration, which is to integrate the automated vendor noncompliance reporting system application (a.k.a., the “System 10”) into a purchaser's internal system containing other kinds of applications. In that configuration, the System 10, as part of the internal system 32, resides in the Purchaser Server 30. Again, the Purchaser Server 30 can communicate with the Vendor Server 40 and Carrier Server 50 by a wired or wireless connection over the Communications Network 20. In an alternative configuration, the purchaser-vendor communication can be completed without the Communications Network 20, but via telephones, faxes, emails, etc.

System Operation

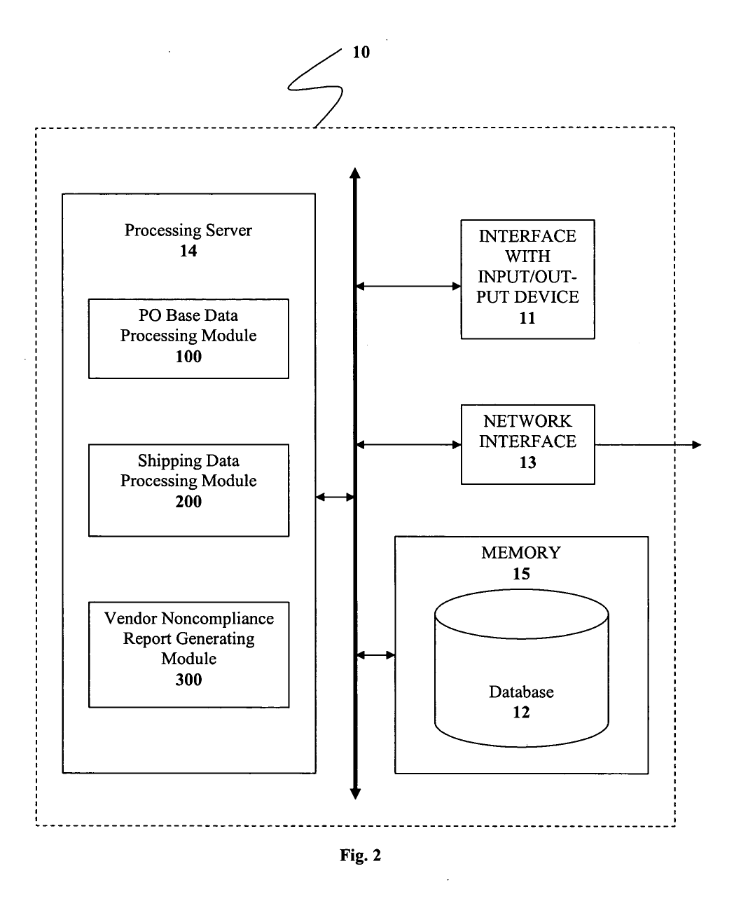

As shown in FIG. 2, the System 10 is comprised of the Processing Server 14, a memory 15 containing the Database 12, an interface device for input/output 11 and a network interface 13. The Processing Server 14 of the System 10 is configured to execute at least three application modules: a Purchaser Order (PO) Base Data Processing Module 100, a Shipping Data Processing Module 200 and an Automated Vendor Non-compliance Reporting Module 300. As shown in FIG. 2, when executing the application modules, the Processing Server 14 is capable of accessing the Database 12 for retrieving or storing necessary data. Each application module and involved data will be described in detail below.

Purchaser Order (PO) Base Data Processing Module

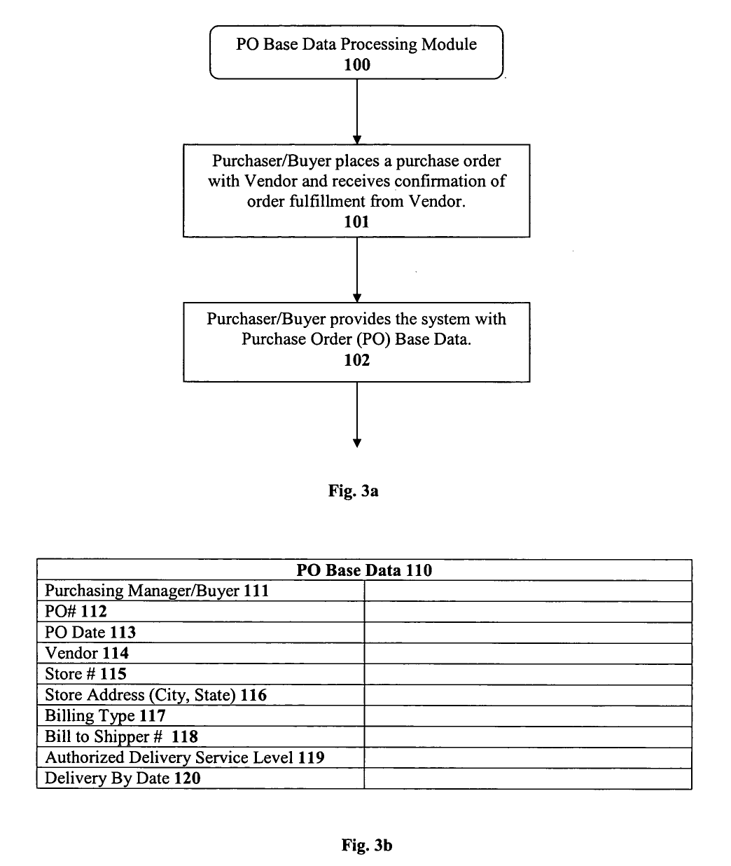

FIG. 3a illustrates that the PO Base Data Receiving Module 100 is primarily comprised of two Steps 101 and 102. In a purchaser-vendor transaction, typically, the purchaser places a purchaser order with one or more vendors designating the goods or products to be purchased. In the purchase order, the purchaser would specify, as an example, the quality and quantity of ordered merchandise, when to deliver the merchandise, where to deliver the merchandise (e.g., address of a retail store, a warehouse, a service center, a subsidiary plant), which carrier to be used for shipping the merchandise (e.g., UPS, FedEX, US Airborne), what level of delivery service to be authorized (e.g., Next-Day Air, Ground Shipment, Express Shipment), and by what date the merchandise to be delivered, etc. The vendor(s) also can be provided with a billing account that the purchaser has with the carrier for billing the cost of merchandise shipment. The vendor(s) who receive the purchase order would make a confirmation back with the purchaser that the order would be fulfilled in accordance with the specified requirements.

The order placement and confirmation between a purchaser and one or more vendors in Step 101 can be performed through the Communications Network 20, or by telephone calls, faxes, etc. After receiving the confirmation from the vendor(s), the purchaser would provide the Purchase Order Base Data 110 for the System 10. Corresponding to the above-explained two architectural configurations of the System 10, a purchaser can use an operator to enter the Purchase Order Base Data 110 either directly into a server computer that is installed with the System 10, or from a web-based browser provided by a third-party service provider running the System 10 over the Internet. By either means, the Purchase Order Base Data 110 will be stored into the database 12 of the System 10.

The Purchase Order Base Data 110 illustrated in FIG. 3b provides an exemplary showing of purchaser order related data in the retail industry where the distribution company may be associated with multiple retail stores. As seen in FIG. 3b, the Purchase Order Base Data 110 may contain such information as a purchasing manager identifier 111, a purchase order number 112, a purchase order date 113, a vendor identifier 114, a store identifier 115 and an associated store address 116, a billing type 117 (e.g., prepaid), a bill to shipper number 118, an authorized delivery service level 119 and a delivery by date 120, although more, less, or other types of data could also be used without departing from the invention.

The purchase order number 112 identifies a particular purchaser order, which may be placed with more than one vendor by the purchaser. For example, a purchaser may need to place an order for the same type of merchandise with various vendors when one vendor has an insufficient supply. To distinguish vendors, the vendor identifier 114 further specifies which vendor is to be used for the order. The store identifier 115 and the associated store address 116 identify the destination where the ordered goods/products/merchandise are to be shipped. The Bill-to-Shipper number 118 is normally the purchaser's corporate account with the carrier. The billing type 117 can be Prepaid, COD, or any other type of payment schedule selected by the purchaser with the carrier. The authorized delivery service level 119 can be Next-Day Air, Ground Shipment, Express Shipment, or any other type of delivery service level selected by the purchaser.

Shipping Data Processing Module

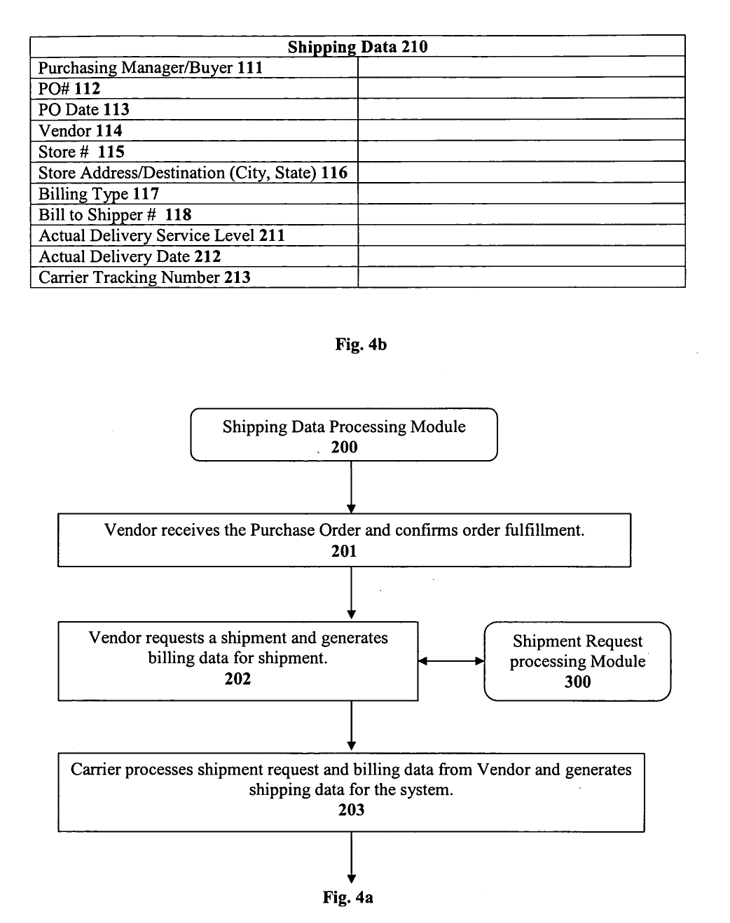

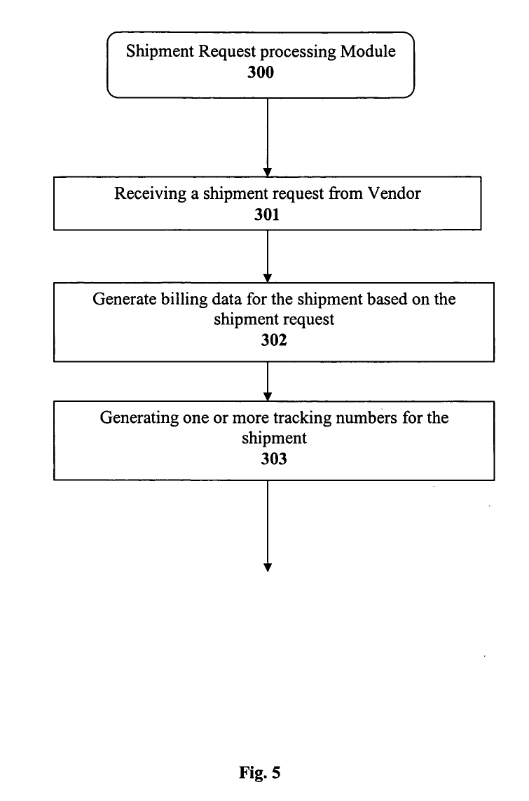

As shown in FIG. 4a, the Shipping Data Receiving Module 200 contains three steps: Step 201, Step 202 and Step 203. The Step 202 is accomplished by a Shipment Request processing module 300.

In Step 201, as stated above, the vendor(s) would confirm with the purchaser their agreement to fulfill the purchase order. Then in the process of order fulfillment, the vendor(s) would request the designated carrier to ship the ordered goods or products to the designated store destination in accordance with Step 202.

To make this shipment request will trigger the Shipment Request Processing Module 300 as illustrated in FIG. 5. The Shipment Request Processing Module 300 is comprised of program instructions comprising Step 301, Step 302 and Step 303.

In Step 301, the Shipment Request Processing Module 300 receives a shipment request from a vendor. In other words, the vendor provides information such as, but not limited to, the quantity, weight, size of packages in which goods or products are enclosed, ship-from address, ship-to address, shipper's name or identity, recipient's name or identity, requested delivery service level, requested delivery date, and billing/payment method. Based upon such information, billing data which contains who to be billed and how much to be billed will be generated in Step 302. As seen in Step 303, further generated are one or more tracking numbers, each of which is used to track one of the several packages to be shipped.

Preferably, the Shipment Request Processing Module 300 is also capable of generating and printing carrier-customized shipment labels, such as a UPS express shipment label, a UPS ground shipment label, for the vendor(s) to fix shipping labels onto the packages, and either drop off the labeled packages in any carrier stores or request a pickup by the carrier's representatives.

The Shipment Request Processing Module 300 can be part of the internal application system of vendor(s). Typically, a carrier provides customers with a customized application to generate tracking numbers and shipping labels to meet the customer' constant shipment needs. Such a customized application can be integrated into a customer's internal system. In an alternative configuration, the carrier maintains a web-based interface (e.g., web browser, web page) from which a shipper customer can make a shipment request and be provided tracking numbers and computer-formatted shipping labels for printing hard copies.

Turning back to FIG. 4a, Step 203 shows the above-described PLD (Package Level Detail) data and billing data generated for the shipment request will be uploaded into the carrier's shipping system over the Communications Network 20. When the carrier receives the packages from the vendor(s), the packages are labeled as ready for shipment in the above-described preferred embodiment; otherwise the carrier's shipping system would search a database storing the uploaded PLD data and billing data to generate necessary shipping labels to be affixed onto the packages. Then the shipping labels affixed on the packages will be scanned to identify the corresponding PLD data and billing data. As a result, shipping data associated with the shipment of the received packages will be generated.

In operation, one carrier may receive packages from various vendors in fulfilling the same purchase order by one purchaser. In that case, the carrier's system can further group shipment information regarding all of the packages for the same order fulfillment and send such information upon the purchaser's request.

The shipping data 210, as exemplified in FIG. 4b, contains a number of data fields, some of which can be the same as in the purchaser order base data 110. These data fields include the purchasing manager identifier 111, the purchase order number 112, the purchase order date 113, the vendor identifier 114, the store identifier 115 and associated store address 116 identifying the destination where the ordered products are to be shipped, the billing type 117 (e.g., prepaid) and the bill to shipper number 118. In addition, the shipping data 210 contains an actual delivery service level 211, an actual delivery date 212, and a carrier tracking number 213.

From the perspective of a purchaser, such shipping data 210 provides visibility into the status of the packages shipped by the vendors. Such visibility can be illustrated in the Quantum View Service provided by the United Parcel Services (UPS), Inc, which simultaneously provides an inbound view regarding the packages shipped by a purchaser's vendors and suppliers to designated destinations, and an outbound view regarding the packages manifested and billed to the purchaser's UPS account. By means of this visibility feature of the shipping data, the purchaser may keep track of all of the packages while they are still in shipment. Furthermore, the shipping data 210 may be captured at the time of shipment. If the captured shipment data 210 is compared against the purchase order base data, vendor non-compliant occurrences can be tracked in a very timely matter.

Automated Vendor Noncompliance Reporting Module

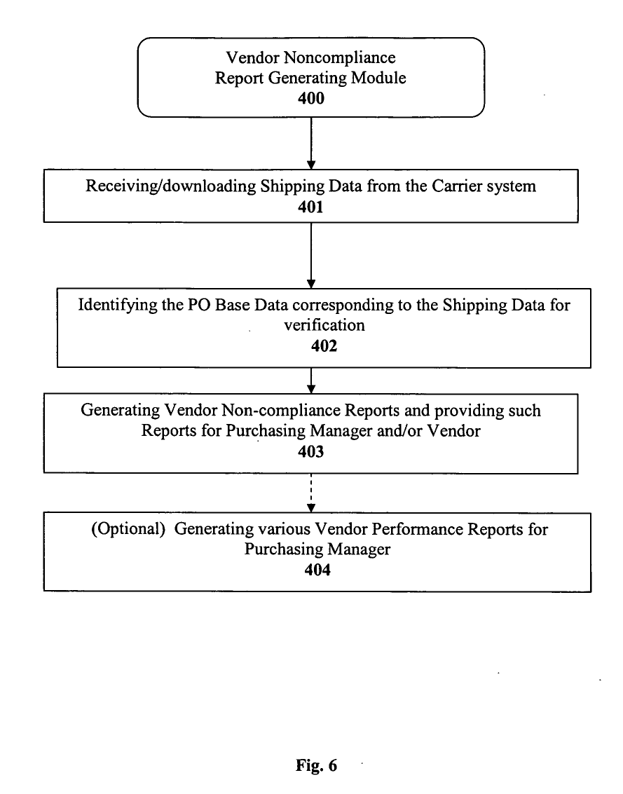

FIG. 6 is the workflow of the Vendor Noncompliance Reporting Module 400. This module starts with Step 401 to receive or download the shipping data associated with the purchaser order from the carrier's system. Based upon a reference number, which can be the purchase order number 111 or the bill to shipper number 118, the Processing Server 14 of the System 10 will search the database 12 to identify the purchase order base data 110 in accordance with Step 402. Then the Processing Server 14 is configured to verify the shipping data against the base data. Specifically, the Processing Server 14 would determine whether the shipping data 210 and the base data 110 match each other pursuant to a set of purchaser-defined criteria. For instance, the Processing Server 10 compares the authorized delivery service level against the actual delivery service level. If the purchaser has authorized the ground shipment while the actual delivery service that the vendor requested is next-day-air service, there exists an instance of vendor noncompliance to be reported.

As illustrated in Step 403, the System 10 will then generate a noncompliance report that describes this non-complying instance and notify the purchaser and/or vendor the generation of this report. Vendor incompliance can occur in many other circumstances, e.g., the authorized delivery by date is not matching the actual delivery date, the billing type is correct, etc.

In addition, Step 404 provides that the system may generate various reports depending on the purchaser's specific requests. For instance, the purchaser may request a purchaser order report listing all packages by all vendors for a specific purchaser order number or all packages by all vendors for all of the purchase orders made by the purchaser. Another example is a vendor performance report listing a specific vendor's performances for a period of time. The purchaser can also select a specific store identifier and obtain a store report listing all packages containing ordered products for that specific store. As can be easily appreciated, all of the reports are generated based upon the purchaser order base data 110 in combination with the shipping data 210.

The automated vendor noncompliance reporting system 10, which comprises an ordered listing of application steps can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

1. A method for automated reporting of vendor noncompliance, said method comprising the steps of:
(A) receiving, from a purchaser, base data associated with a purchase order, said purchaser placing said purchase order with a vendor, said base data comprising at least a purchase order number, a billing number and an authorized delivery service level;
(B) receiving, from a carrier, shipping data associated with said purchase order, said shipping data generated upon a shipment request from said vendor to said carrier, and said shipping data comprising at least said purchase order number, said billing number and an actual delivery service level;
(C) determining whether there exists noncompliance by said vendor by comparing said shipping data against said base data in accordance with a set of pre-defined rules; and
(D) responsive to the determination that said noncompliance exists, reporting said noncompliance to said vendor and said purchaser.

2. The method of claim 1, wherein said base data further comprises a delivery by date.

3. The method of claim 2, wherein said shipping data further comprises an actual delivery date.

4. The method of claim 1, wherein said shipping data is generated through the steps of:
(1) allowing said vendor to make said shipment request through a shipper application;
(2) upon receiving said shipment request, said shipper application generating billing data associated with said purchase order, said billing data comprising at least said purchase order number, said billing number, said actual delivery service level and a shipment tracking number; and
(3) transferring said billing data to a shipping system of said carrier, said shipping system generating said shipping data.

5. The method of claim 1, wherein said noncompliance is determined to exist if said actual delivery service level does not match said authorized delivery service level.

6. The method of claim 3, wherein said noncompliance is determined to exist if said actual delivery date does not match said delivery by date.

7. The method of claim 1, wherein said shipping data is downloaded from a shipping system of said carrier.

8. The method of claim 1, wherein said noncompliance is reported to said purchaser and said vendor via email notifications.

9. A method for automated reporting of vendor noncompliance, said method comprising the steps of:
(A) allowing a purchaser to set up a set of pre-defined rules for vendor compliance;
(B) receiving, from said purchaser, base data associated with a purchase order, said purchaser placing said purchase order with a vendor, said base data comprising at least a purchase order number, a billing number and an authorized delivery service level;
(B) receiving, from a carrier, shipping data associated with said purchase order, said shipping data generated upon a shipment request from said vendor to said carrier, and said shipping data comprising at least said purchase order number, said billing number and an actual delivery service level;
(C) determining whether there exists noncompliance by said vendor by comparing said shipping data against said base data in accordance with said set of pre-defined rules; and
(D) responsive to the determination that said noncompliance exists, reporting said noncompliance to said vendor and said purchaser.

10. A system for automated reporting of vendor noncompliance, comprising:
a processing server; and
a database accessible to said processing server, said database storing base data associated with a plurality of purchase orders, said base data comprising at least a plurality of purchase order numbers, a plurality of billing numbers and a plurality of delivery service levels authorized by a purchaser;
wherein, said processing server is configured for:
receiving shipping data associated with a particular purchase order, said shipping data comprising at least a particular purchase order number, a particular billing number, and a particular actual delivery service level;
searching said database to identify, from said base data, a particular base data corresponding to said particular purchase order based upon said particular purchase order number and said particular billing number;
comparing said shipping data against said particular base data to determine whether there is noncompliance, and if so, reporting said noncompliance to said purchaser.

11. The system of claim 10, wherein said processing server is further configured to receive said base data from said purchaser over a communications network every time when said purchasers places a purchase order with a vendor.

12. The system of claim 11, wherein said communications network is one selected from the group of the Internet and a local network.

13. The system of claim 10, wherein said shipping data is generated in a carrier's shipping system through the steps of:
(A) receiving said particular purchase order from said purchaser;
(B) in response to receiving said particular purchase order, allowing a vendor to request from a carrier a shipment service for ordered products;
(C) generating billing data associated with said shipment service, said billing data including said particular purchase order number and said particular billing number; and
(D) receiving said billing data in said carrier's shipping system to generate said shipping data upon said shipment service.

14. The system of claim 10, wherein said noncompliance is determined to exist if said particular actual delivery service level in said shipping data does not match a particular authorized delivery service level in said particular base data.

15. The system of claim 10, wherein said base data further comprises a plurality of authorized dates by which ordered products should be delivered.

16. The system of claim 10, wherein said shipping data further comprises a particular actual delivery date.

17. The system of claim 16, wherein said noncompliance is determined to exist if said particular actual delivery date in said shipping data does not match a particular delivery by date in said particular base data.

18. A computer-readable medium for vendor compliance, said computer-readable medium comprising programmed instructions, said programmed instructions, when executed in a computer, comprising the steps of:
(A) receiving, from a purchaser, base data associated with a purchase order, said purchaser placing said purchase order with a vendor, said base data comprising at least a purchase order number, a billing number and an authorized delivery service level;
(B) receiving, from a carrier, shipping data associated with said purchase order, said shipping data generated upon a shipment request from said vendor to said carrier, and said shipping data comprising at least said purchase order number, said billing number and an actual delivery service level;
(C) determining whether there exists noncompliance by said vendor by comparing said shipping data against said base data in accordance with a set of pre-defined rules; and
(D) responsive to the determination that said noncompliance exists, reporting said noncompliance to said vendor and said purchaser.

19. The computer-readable medium of claim 18, wherein said programmed instructions further comprise the steps of:
(E) allowing said vendor to make said shipment request through a shipper application;
(F) upon receiving said shipment request, said shipper application generating billing data associated with said purchase order, said billing data comprising at least said purchase order number, said billing number, said actual delivery service level and a shipment tracking number; and
(G) transferring said billing data to a shipping system of said carrier, said shipping system generating said shipping data.

20. A method for a purchaser to track vendor compliance, said method comprising the steps of:
(A) said purchaser placing a purchase order with a vendor, said purchase order identifying products to be purchased;
(B) said purchaser receiving from said vendor a confirmation of fulfilling at least a portion of said purchase order;
(C) in response to receiving from said vendor said confirmation, said purchaser inputting base data associated with said purchase order for a noncompliance reporting application, said base data comprising at least a purchase order number, a billing to shipper number and specific delivery instructions for shipping said products; and
(D) said purchaser receiving, from said noncompliance reporting application, a report of noncompliance by said vendor in handling a shipment of said products, said report being generated by said noncompliance reporting application through the steps of:
(1) storing said base data in a database;
(2) receiving, from a carrier's system, shipping data relating to said shipment of said products, said shipping data comprising at least said purchase order number, said billing to shipper number and actual delivery information;
(3) responsive to receiving said shipping data, searching said database to identify said base data for a comparison against said shipping data; and
(4) determining whether there is noncompliance based upon said comparison, and if so, including said noncompliance in said report.

21. The method of claim 20, wherein said carrier's system is configured to receive shipment billing data from said vendor prior to generating said shipping data, said billing data comprising at least said purchase order number, said billing to shipper number and a shipment tracking number.

22. The method of claim 20, wherein said noncompliance reporting application is executed in a server computer having access to said database.

23. The method of claim 20, wherein said specific delivery instructions for shipping said products comprise an authorized delivery service level.

24. The method of claim 20, wherein said specific delivery instructions for shipping said products comprise an authorized delivery by date.

25. The method of claim 20, further comprising the steps of:
(D) inputting said purchase order number for said noncompliance reporting application to communicate with said carrier's system; and
(E) receiving a shipment status report from said noncompliance reporting application, said shipment status report including shipping information of all packages associated with said purchase order number.

26. The method of claim 20, further comprising the steps of:
(F) inputting said billing to shipper number for said noncompliance reporting application to communicate with said carrier's system; and
(G) receiving a shipment summary report from said noncompliance reporting application, said shipment summary report including shipping data of all packages associated with said billing to shipper number.

27. A system for facilitating vendor compliance comprising:
a processing server;
a database accessible to said processing server; and
a reporting application, when executed in said processing server, comprising the steps of:
receiving from a user base data relating to a plurality of purchase orders identifying products to be ordered, each of said plurality of purchase orders containing a purchase order number, a vendor identifier, a billing number identifying said user, a shipping destination and approved delivery specifications;
storing said base data into said database;
receiving from a carrier shipping data associated with said plurality of purchase orders, said shipping data including actual shipment statuses for each of said plurality of purchase orders;
for each of said plurality of purchase orders, comparing respective shipping data against respective base data; and
reporting vendor noncompliance that is identified from the comparison pursuant to a set of user-defined criteria.

28. The system of claim 27, wherein said set of user-defined criteria includes a criterion that there is vendor noncompliance associated with one purchase order if an actual shipment status of said one purchase order does not match approved delivery specifications of said one purchase order.

29. The system of claim 27, wherein said reporting application further comprises the steps of:
allowing said user to input a particular purchase order;
searching said database to identify particular shipping data associated with said particular purchase order, said shipping data comprising information of all packages in shipment and fulfillment of said particular purchase order; and
reporting said particular shipping data to said user.

30. The system of claim 27, wherein said reporting application further comprises the steps of:
searching said database to identify particular shipping data that comprises said billing to shipper number; and
reporting said particular shipping data to said user.

31. The system of claim 27, wherein said reporting application further comprises the steps of:
searching said database to identify particular shipping data associated with a same vendor, and reporting said particular shipping data to said user.

32. The system of claim 27, wherein said reporting application further comprises the steps of:
searching said database to identify particular shipping data associated with a same shipping destination, and reporting said particular shipping data to said user.

33. A method for automated reporting of vendor noncompliance, said method comprising the steps of:
(A) receiving, from a purchaser, base data associated with a purchase order with a vendor for purchasing products, said base data comprising at least a purchase order number, an account number to bill said purchaser, and a designated delivery service level;
(B) storing said base data in a computer system, said computer system including at least one database;
(C) receiving, from said vendor, a shipment request for a carrier to ship said products in connection with said purchase order, said shipment request received by said carrier through a shipper application that is configured for:
(1) processing said shipment request to capture shipping data including said purchase order number, said account number to bill said purchaser, a ship-to address, a ship-from address and a delivery service level,
(2) transferring and storing said shipping data in a carrier's computer system,
(3) generating one or more shipping labels, each of said one or more shipping labels identified by a tracking number, and
(3) providing for said vendor said one or more shipping labels in an electronic form to be printed and affixed to containers enclosing said products;
(D) downloading said shipping data from said carrier's computer system automatically into said computer system;
(E) determining whether there exists noncompliance by said vendor by comparing said shipping data with said base data in accordance with a set of pre-defined rules; and
(F) responsive to the determination that said noncompliance exists, sending a notification to said vendor about said noncompliance and reporting said noncompliance to said purchaser.
